(19) United States
(12) Patent Application Publication
(10) Pub. No.: US 2018/0045133 A1
(43) Pub. Date: Feb. 15, 2018

(54) DETERMINATION OF A POINT IN TIME OF A PREDETERMINED OPEN STATE OF A FUEL INJECTOR

(71) Applicant: CONTINENTAL AUTOMOTIVE GMBH, Hannover (DE)

(72) Inventor: Frank Denk, Obertraubling (DE)

(73) Assignee: CONTINENTAL AUTOMOTIVE GMBH, Hannover (DE)

(21) Appl. No.: 15/791,059

(22) Filed: Oct. 23, 2017

Related U.S. Application Data
(63) Continuation of application No. PCT/EP2016/058125, filed on Apr. 13, 2016.

(30) Foreign Application Priority Data
Apr. 29, 2015 (DE) 10 2015 207 954.6

(51) Int. Cl. F02D 41/24

(52) U.S. Cl. CPC F02D 41/2467; F02D 2041/2013

(57) ABSTRACT

A method for determining the point in time of a predetermined open state of a fuel injector having a solenoid drive for a combustion engine of a motor vehicle. The method includes detection of a time profile of the current level of a current flowing through the solenoid drive during a boost phase, where the solenoid drive is subjected to a first voltage during a first part of the boost phase and a second voltage during a second part of the boost phase. The second voltage is selected so that the current level of the current flowing through the solenoid drive during the second part of the boost phase essentially remains unchanged, and determination of a point in time at which the detected time profile of the current level has an extreme value, where the determined point in time is the point in time of the predetermined open state.

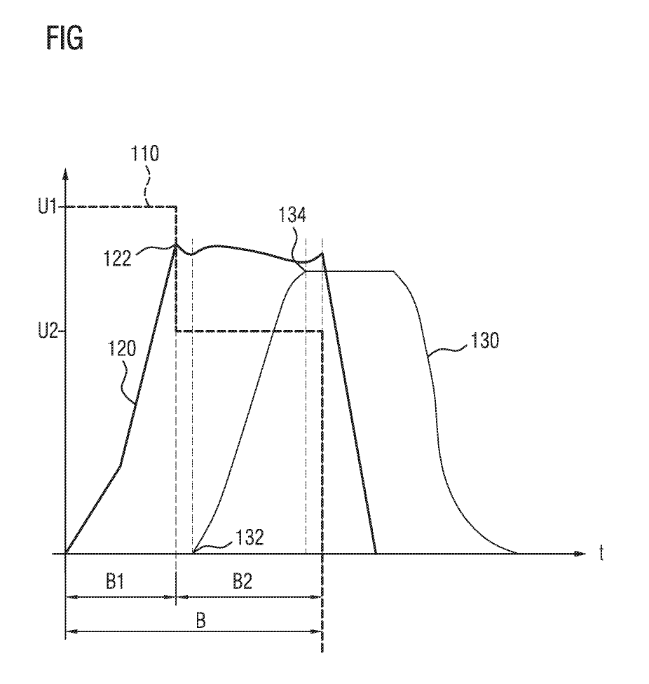

### CROSS-REFERENCE TO RELATED APPLICATIONS

This application claims the benefit of PCT Application PCT/EP2016/058125, filed Apr. 13, 2016, which claims priority to German Application DE 10 2015 207 954.6, filed Apr. 29, 2015. The disclosures of the above applications are incorporated herein by reference.

### FIELD OF THE INVENTION

The present invention concerns the technical field of the actuation of fuel injectors. The present invention concerns in particular a method for determining the point in time of a predetermined open state of a fuel injector including a solenoid drive. The present invention also concerns methods for actuating a fuel injector including a solenoid drive for a combustion engine of a motor vehicle, an engine controller and a computer program.

### BACKGROUND OF THE INVENTION

During the operation of fuel injectors with solenoid drives, owing to electrical tolerances different temporal opening behavior of the individual injectors occurs and thus variations in the respective injection amounts occur.

The relative differences in injection amounts from injector to injector increase as injection times become shorter. Up to now, the relative differences in amounts were small and without practical significance. However, as a result of the development towards smaller injection amounts and shorter injection times, the influence of the relative differences in amounts can no longer be ignored.

The time profile of the current level during a fuel injector opening process (in which the solenoid drive is subjected to a voltage pulse (boost voltage)) depends on the inductance of the solenoid drive. In addition to the varying intrinsic inductance of the solenoid drive (owing to the non-linear ferromagnetic magnet material), a motion inductance component occurs owing to the armature movement. The motion inductance component starts at the start of the opening phase (armature/needle movement starts) and ends at the end of the opening phase (armature/needle movement ends).

### SUMMARY OF THE INVENTION

The object of the present invention is to provide an improved and simple method for determining the point in time of a predetermined open state of a fuel injector including a solenoid drive for a combustion engine of a motor vehicle.

The above object is achieved by the subjects of the independent claims. Advantageous embodiments of the present invention are described in the dependent claims.

According to a first aspect of the invention, a method is described for determining the point in time of a predetermined open state of a fuel injector including a solenoid drive for a combustion engine of a motor vehicle. The method described comprises the following: (a) detection of a time profile of the current level of a current flowing through the solenoid drive during a boost phase, wherein the solenoid drive is subjected to a first voltage during a first part of the boost phase and to a second voltage during a second part of the boost phase and wherein the second voltage is selected so that the current level of the current flowing through the solenoid drive essentially remains unchanged during the second part of the boost phase, and (b) determination of a point in time at which the detected time profile of the current level has an extreme value, wherein the determined point in time is the point in time of the predetermined open state.

The method described is based on the knowledge that if the current (coil current) flowing through the solenoid drive remains approximately unchanged, then the variation with time of the linked magnetic flux depends mainly on the motion inductance. The motion inductance changes in connection with defined movement states in certain ways, and thus the corresponding points in time may be determined by analysis of the time profile of the current level, in particular identification of extreme values in the time profile of the current level.

In other words, the coil current is set according to the following general electrical-magnetic equation:

$$u ( t ) = i ( t ) {R}_{Coil} + \frac{d Ψ ( i ( t ) , x ( t ) )}{dt}$$

Here u(t) denotes the voltage and i(t) the coil current as functions of time. R_{Coil} is the electrical resistance of the coil drive, Ψ(t) is the linked magnetic flux and x(t) is the position of the movable armature of the solenoid drive.

In the above equation, the variation with time of the linked magnetic flux may be divided as follows:

$$\frac{d Ψ ( i ( t ) , x ( t ) )}{dt} = \frac{\partial Ψ ( i ( t ) , x ( t ) )}{\partial i ( t )} \frac{\partial i ( t )}{\partial t} + \frac{\partial Ψ ( i ( t ) , x ( t ) )}{\partial x ( t )} \frac{\partial x ( t )}{\partial t} = {L}_{Coil} ( x ) \frac{di}{dt} + \frac{d Ψ ( i )}{dx} \dot{x}$$

Here L_{Coil} denotes the inductance of the coil and \dot{x} denotes the speed of the movable armature. In the case of an essentially constant coil current, i.e. di/dt≈0, the movement term dΨ/dx·dx/dt dominates. Consequently, for example the motion states start and end of the opening of the injector may be detected from relative extreme values in the time profile of the coil current.

In this document “boost phase” denotes in particular subjecting the solenoid drive to a voltage pulse that has a raised voltage compared to the vehicle voltage and is also designed to open the fuel injector by moving the armature rapidly. The boost phase consists here of two successive parts or segments, wherein in the first part the first voltage is applied and in the second part the second voltage is applied.

The determination of a point in time at which the detected time profile of the current level has an extreme value is carried out by numerical analysis, for example forming the gradient of and/or differentiating the detected time profile of the current level.

In the method described, during the start of injection a current profile with an increased first boost voltage compared to the battery voltage is set, wherein the coil current increases. In the second part of the boost phase, the boost voltage is set to a second voltage that is also increased compared to the battery voltage and further is selected so that the coil current (in the event of free movement of the armature) remains essentially constant. In this case, a change in the coil current may be traced back to a change in the armature speed, so that for example the end of the opening process is detected by the speed of the armature decreasing abruptly at the stop.

According to an exemplary embodiment of the invention, the second voltage is smaller than the first voltage.

A high current level in the first part of the boost phase is thus reached rapidly, and subsequently is essentially held constant in the second part of the boost phase.

According to a further exemplary embodiment of the invention, the first part of the boost phase ends and the second part of the boost phase starts when the current level of the current flowing through the solenoid drive reaches a predetermined value.

The predetermined value of the current level (also known as the peak current) depends on the injector inductance (L_{Coil}) and is large enough for sufficient force to be provided for opening the injector.

According to a further exemplary embodiment of the invention, the current level of the current flowing through the solenoid drive reaches the predetermined value before a movement of an armature of the solenoid drive starts.

In other words, the time duration of the first part of the boost phase is adjusted so that the actual fuel injector opening process (with armature movement) only occurs in the second part of the boost phase. It is thus ensured that the start of the armature movement may also be precisely determined.

According to a further exemplary embodiment of the invention, the level of the first voltage is about 65V and the level of the second voltage is in the region of 25V to 50V.

The exact value of the second voltage depends on the fuel injector, but is in general somewhat lower than the first voltage and at the same time higher than the onboard voltage in the vehicle (12V).

According to a further exemplary embodiment of the invention, the determined point in time of the predetermined open state of the fuel injector is a start or end time of a fuel injector opening process.

The start of the opening process takes place for example when the movement of the armature starts, and may be detected by detecting a change in the coil current caused by the corresponding change in armature speed. Alternatively, the start of the opening process takes place when the armature that is already moving drives the injector needle with it after overcoming free play. Here too there is a detectable change in the coil current.

The end of the opening process occurs when the movement of the armature is braked by a stop, and may also be detected by detecting a change in the coil current caused by the corresponding change in the armature speed.

According to a second aspect of the invention, a method is described for actuating a fuel injector including a solenoid drive for a combustion engine of a motor vehicle. The method described comprises the following: (a) determining the point in time of a predetermined open state of the fuel injector by using the method according to the first aspect or one of the above exemplary embodiments, (b) determining a difference between the determined point in time and a reference point in time, and (c) actuating the fuel injector, wherein the solenoid drive is subjected to a voltage pulse, the starting time of which and/or the time duration of which is determined based on the determined difference.

The voltage pulse with which the fuel injector is actuated advantageously comprises two parts with a first voltage and a second voltage and thus constitutes the boost phase used in the first aspect.

In other words, the actuation and detection of the points in time of predetermined open states are carried out in the same way.

If it is determined that a detected point in time of a corresponding reference point in time deviates, the start time and/or time duration of the voltage pulse is adjusted, so that the predetermined open states occur at the respective desired points in time and it is ensured that exactly the specified injection amount is achieved.

According to a third aspect of the invention, an engine controller is described for a combustion engine of a motor vehicle, wherein the engine controller is designed for carrying out the method according to the first and second aspects and/or one of the above exemplary embodiments.

The engine controller enables the points in time of predetermined open states of a fuel injector to be determined in a simple way and to be taken into account during the actuation in order to achieve precise injection.

According to a fourth aspect of the invention, a computer program is described, which, when executed by a processor, is designed for carrying out the method according to the first and second aspects and/or one of the above exemplary embodiments.

For the purposes of this document, the naming of such a computer program is synonymous with the term program element, computer program product and/or computer-readable medium containing instructions for controlling a computer system in order to coordinate the operation of a system or of a method in a suitable manner, in order to achieve the combined effects with the method according to the invention.

The computer program may be implemented as a computer-readable instruction code in any suitable programming language, such as for example in JAVA, C++ etc. The computer program may be stored on a computer-readable memory medium (CD-ROM, DVD, Blu-ray disk, replaceable disk drive, volatile or non-volatile memory, integral memory/processor etc.). The instruction code may program a computer or other programmable unit, such as in particular a control unit for an engine of a motor vehicle, so that the desired functions are implemented. Furthermore, the computer program may be provided in a network, such as for example the Internet, from which it may be downloaded as required by a user.

The invention may be implemented both by using of a computer program, i.e. software, and also by using of one or more special electrical circuits, i.e. in hardware, or in any hybrid form, i.e. by use of software components and hardware components.

It is noted that embodiments of the invention have been described with reference to different subjects of the invention. In particular, some embodiments of the invention are described with method claims and other embodiments of the invention with equipment claims. To the person skilled in the art, however, when reading this application it is immediately clear, if not explicitly stated otherwise, that in addition to a combination of features that belong to a type of subject of the invention, any combination of features that belong to different types of subject of the invention is possible.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

The FIGURE shows an example of a profile of voltage, current level and amount of fuel input as functions of time during the actuation of a fuel injector according to the invention.

### DETAILED DESCRIPTION OF THE PREFERRED EMBODIMENTS

The following description of the preferred embodiment(s) is merely exemplary in nature and is in no way intended to limit the invention, its application, or uses.

Further advantages and features of the present invention arise from the following exemplary description of a preferred embodiment.

It is noted that the embodiment described below only represents a limited selection of possible versions of embodiments of the invention.

The FIGURE shows the profile of voltage 110, current level 120 and amount of fuel input 130 as functions of time t during the actuation of a fuel injector according to the invention, in particular during a boost phase B.

The boost phase B starts with a first part B1, in which the solenoid drive of the fuel injector is subjected to a first boost voltage U1. The first voltage U1 is significantly greater than the voltage of the vehicle battery and is for example approx. 65 V. During the first part B1 of the boost phase B, the current level 120 of the current flowing through the solenoid drive increases strongly and reaches a predetermined maximum value (peak current) 122 at the end of the first part B1 of the boost phase B. At this point in time, the second part B2 of the boost phase B starts, and the solenoid drive of the fuel injector is now subjected to a second boost voltage U2, which is somewhat lower than U1, for example in the region of 25V to 50V. The second boost voltage U2 is selected so that the profile of the coil current 120 during the second part B2 of the boost phase B is essentially horizontal, i.e. the coil current 120 essentially remains constant. Thus, significant changes in the motion inductance cause significant detectable changes in the coil current 120, as has been described above.

Shortly after the start of the second part B2 of the boost phase B, the actual opening process of the fuel injector starts and the amount of fuel input 130 starts to rise, as seen at 132. The end of the opening process ends at 134, where the amount of fuel input 130 reaches the maximum value thereof. The maximum value is maintained until the start of a subsequent closing process.

The profile of the current level 120 is sampled and mathematical and/or numerical methods are used to identify extreme values. As the current graph 120 shows, despite the essentially constant current value during the second part B2 of the boost phase B there is a local minimum in the current level 120 both at the start 132 and at the end 134 of the opening phase. The minima are detected and associated with the start 132 and the end 134.

The engine control unit now compares the detected points in time with reference values and determine whether corrections are necessary in order to achieve the specified injection amounts. Depending on the result of this comparison, the engine control unit then corrects the start time and/or time duration of the actuation. If the point in time of opening is shifted, the engine control unit shifts the start of the actuation accordingly, and if the point in time of the end of the opening is shifted, the engine control unit adjusts the injection duration accordingly.

The corrections are advantageously carried out pulse-specifically. Furthermore, during the correction, further physical system parameters may be taken into account, such as for example fuel temperature and the time since the previous injection. The corrections may advantageously be stored in the control unit for this as pilot control characteristic curves/fields or calculated using a suitable model.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for operating a fuel injector, comprising the steps of:
providing a motor vehicle;
providing a combustion engine, the combustion engine being part of the motor vehicle;
providing a solenoid drive, the solenoid drive being part of the combustion engine;
providing a boost phase;
detecting a time profile of the current level of a current flowing through the solenoid drive during the boost phase;
subjecting the solenoid drive to a first voltage during a first part of the boost phase;
subjecting the solenoid drive to a second voltage during a second part of the boost phase;
selecting the second voltage such that the current level of the current flowing through the solenoid drive during the second part of the boost phase remains substantially unchanged;
determining a point in time at which the detected time profile of the current level has an extreme value, and the determined point in time is the point in time of a predetermined open state of a fuel injector.

2. The method of claim 1 further comprising the steps of providing the second voltage to lower than the first voltage.

3. The method of claim 1, further comprising the steps of ending the first part of the boost phase and beginning the second part of the boost phase when the current level of the current flowing through the solenoid drive reaches a predetermined value.

4. The method of claim 1, further comprising the steps of the current level of the current flowing through the solenoid drive reaching the predetermined value before a movement of an armature of the solenoid drive starts.

5. The method of claim 1, further comprising the steps of providing the first voltage to be approximately 65 Volts.

6. The method of claim 1, further comprising the steps of providing the second voltage to be between 25 Volts and 50 Volts.

7. The method of claim 1, further comprising the steps of providing the determined point in time of the predetermined open state of the fuel injector to be at least one of a start point in time or an end point in time of a fuel injector opening process.

8. The method of claim 1, further comprising the steps of:
providing a reference point in time;
determining a difference between the reference point in time and the determined the point in time of the predetermined open state of the fuel injector; and
actuating the fuel injector;
subjecting the solenoid drive to the first voltage pulse, such that the starting time of first voltage pulse and the time duration of the first voltage pulse is determined based on the determined difference.

9. The method of claim 1, further comprising the steps of:
providing a reference point in time;
determining a difference between the reference point in time and the determined the point in time of the predetermined open state of the fuel injector; and
actuating the fuel injector;
subjecting the solenoid drive to the first voltage pulse, such that the starting time of first voltage pulse is determined based on the determined difference.

10. The method of claim 1, further comprising the steps of:
providing a reference point in time;
determining a difference between the reference point in time and the determined the point in time of the predetermined open state of the fuel injector; and
actuating the fuel injector;
subjecting the solenoid drive to the first voltage pulse, such that the time duration of the first voltage pulse is determined based on the determined difference.

11. A computer program for determining the point in time of a predetermined open state of a fuel injector having a solenoid drive, the computer program stored in non-transitory memory and including instructions which, when executed by a processor, causes the processor to:
detect a time profile of the current level of a current flowing through the solenoid drive during a boost phase;
subject the solenoid drive to a first voltage during a first part of the boost phase;
subject the solenoid drive to a second voltage during a second part of the boost phase;
select the second voltage such that the current level of the current flowing through the solenoid drive during the second part of the boost phase remains substantially unchanged;
determine a point in time at which the detected time profile of the current level has an extreme value, and the determined point in time is the point in time of a predetermined open state of a fuel injector.

12. The computer program of claim 11, wherein the second voltage to lower than the first voltage.

13. The computer program of claim 11, wherein the first part of the boost phase is ended and the second part of the boost phase is begun when the current level of the current flowing through the solenoid drive reaches a predetermined value.

14. The computer program of claim 11, wherein the current level of the current flowing through the solenoid drive reaches the predetermined value before a movement of an armature of the solenoid drive starts.

15. The computer program of claim 11, wherein the first voltage is approximately 65 Volts.

16. The computer program of claim 11, wherein the second voltage is between 25 Volts and 50 Volts.

17. The computer program of claim 11, wherein the determined point in time of the predetermined open state of the fuel injector to be a start or end point in time of a fuel injector opening process.
